(19) United States
(12) Patent Application Publication
(10) Pub. No.: US 2017/0072637 A1
(43) Pub. Date: Mar. 16, 2017

(54) THREE-DIMENSIONAL SHAPING APPARATUS, THREE-DIMENSIONAL SHAPING METHOD, AND COMPUTER PROGRAM PRODUCT

(71) Applicants: Shinsuke YANAZUME, Tokyo (JP); Hiroshi BABA, Kanagawa (JP)

(72) Inventors: Shinsuke YANAZUME, Tokyo (JP); Hiroshi BABA, Kanagawa (JP)

(21) Appl. No.: 15/262,204

(22) Filed: Sep. 12, 2016

(30) Foreign Application Priority Data
Sep. 14, 2015 (JP) 2015-181201

(51) Int. Cl. B29C 67/00; G06F 17/50; B33Y 50/02; B33Y 10/00; B33Y 70/00; B33Y 30/00

(52) U.S. Cl. CPC B29C 67/0081; B33Y 70/00; B33Y 30/00; B33Y 50/02; B29C 67/0088; B33Y 10/00; G06F 17/50; B29K 2105/251

(57) ABSTRACT

A three-dimensional shaping apparatus is configured to laminate layers of a molding material to shape a three-dimensional object. The three-dimensional shaping apparatus includes: a powder material feeder configured to feed a powder material flat so as to be vertically deposited; a layer information acquiring unit configured to acquire layer information generated in such a manner that information indicating a shape of the three-dimensional object is divided so as to correspond to the layers of the molding material; a binding agent discharging unit configured to discharge a binding agent for binding the powder material selectively to the powder material at a position determined based on the layer information, to bind the powder material to form the layers of the molding material; and an image projecting unit configured to project an image onto a flat surface of the powder material based on projection information generated according to the layer information.

### CROSS-REFERENCE TO RELATED APPLICATIONS

The present application claims priority under 35 U.S.C. §119 to Japanese Patent Application No. 2015-181201, filed Sep. 14, 2015. The contents of which are incorporated herein by reference in their entirety.

### BACKGROUND OF THE INVENTION

1. Field of the Invention

The present invention relates to a three-dimensional shaping apparatus, a three-dimensional shaping method, and a computer program product.

2. Description of the Related Art

In late years, a technology called three-dimensional shaping is used in the field of rapid prototyping, etc. Three-dimensional objects obtained by the three-dimensional shaping are used, in many cases, as prototypes used to evaluate appearance and performance of a final product in a product development stage, or as exhibits and so on.

As one of three-dimensional shaping techniques, the laminating method of shaping and laminating shapes obtained by slicing an objective three-dimensional object to form the three-dimensional object is known. One of three-dimensional shaping apparatuses using the laminating method is a powder laminating shaping printer that feeds a molding material such as powder to a position corresponding to a molding part and supplies a liquid for binding the molding material thereto afterward to form a layer.

In the powder laminating shaping printer, a three-dimensional object to be shaped is formed in a poor visibility state such that the three-dimensional object is buried in uncured powder material.

### SUMMARY OF THE INVENTION

According to one aspect of the present invention, a three-dimensional shaping apparatus is configured to laminate layers of a molding material based on input information to shape a three-dimensional object. The three-the dimensional shaping apparatus includes a powder material feeder, a layer information acquiring unit, a binding agent discharging unit, and an image projecting unit. The powder material feeder is configured to feed a powder material flat so as to be vertically deposited. The layer information acquiring unit is configured to acquire layer information generated in such a manner that information indicating a shape of the three-dimensional object is divided so as to correspond to the layers of the molding material. The binding agent discharging unit is configured to discharge a binding agent for binding the powder material selectively to the flat fed powder material at a position determined based on the layer information, to bind the powder material to form the layers of the molding material. The image projecting unit is configured to project an image onto a flat surface of the powder material based on projection information generated according to the layer information.

### BRIEF DESCRIPTION OF THE DRAWINGS

FIG. 1 is a diagram illustrating an operation form of a system according to some embodiments of the present invention;

FIG. 2 is a block diagram illustrating a hardware configuration of an information processing device according to the embodiments of the present invention;

FIG. 3 is a perspective view illustrating a configuration of a 3D printer according to the embodiments of the present invention;

FIGS. 4A to 4F are views illustrating how to feed powder according to the embodiments of the present invention;

FIG. 5 is a block diagram illustrating a functional configuration of the 3D printer according to the embodiments of the present invention;

FIG. 6 is a block diagram illustrating a functional configuration of a PC according to the embodiments of the present invention;

FIG. 7 is a block diagram illustrating a functional configuration of a 3D data conversion processor according to the embodiments of the present invention;

FIG. 8 is a diagram illustrating how to calculate a distance between an optical lens and a shaping stage according to the embodiments of the present invention;

FIG. 9 a diagram for explaining generation of projection slice data according to the embodiments of the present invention;

FIG. 10 is a flowchart illustrating an example of an operation for projecting the slice data according to the embodiments of the present invention;

FIG. 11 is a block diagram illustrating a functional configuration of a slice processor according to the embodiments of the present invention;

FIG. 12 is a diagram illustrating a synthesis example of a plurality of slice data according to the embodiments of the present invention;

FIG. 13 is a diagram illustrating how to project the synthesized slice data according to the embodiments of the present invention;

FIG. 14 is a flowchart illustrating an example of operations for synthesizing and projecting the slice data according to the embodiments of the present invention;

FIG. 15 is a diagram illustrating a selection of slice data according to the embodiments of the present invention;

FIG. 16 is a flowchart illustrating an example of operations for selecting and projecting the slice data according to the embodiments of the present invention;

FIG. 17 is a diagram illustrating slice data taking a maximum value according to the embodiments of the present invention;

FIG. 18 is a flowchart illustrating an example of an operation for projecting the slice data taking the maximum value according to the embodiments of the present invention;

FIG. 19 is a diagram illustrating how to calculate a progress rate from projection slice data according to the embodiments of the present invention;

FIG. 20 is a flowchart illustrating an operation for projecting the slice data and the progress rate according to the embodiments of the present invention; and

FIG. 21 is a flowchart illustrating an operation for performing shaping after the projection of the slice data according to the embodiments of the present invention.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment has an object to perform localization of a three-dimensional object in a shaping device for laminating layers in which powder material is selectively bound to form a three-dimensional object.

Exemplary embodiments of the present invention will be explained below with reference to the accompanying drawings. The present embodiments will explain a system, as an example, including a 3D printer that receives 3D data indicating a shape of a three-dimensional object such as computer aided design (CAD) data and deposits layers of a molding material to form the three-dimensional object based on the data, and including a personal computer (PC) that transmits the 3D data to the 3D printer.

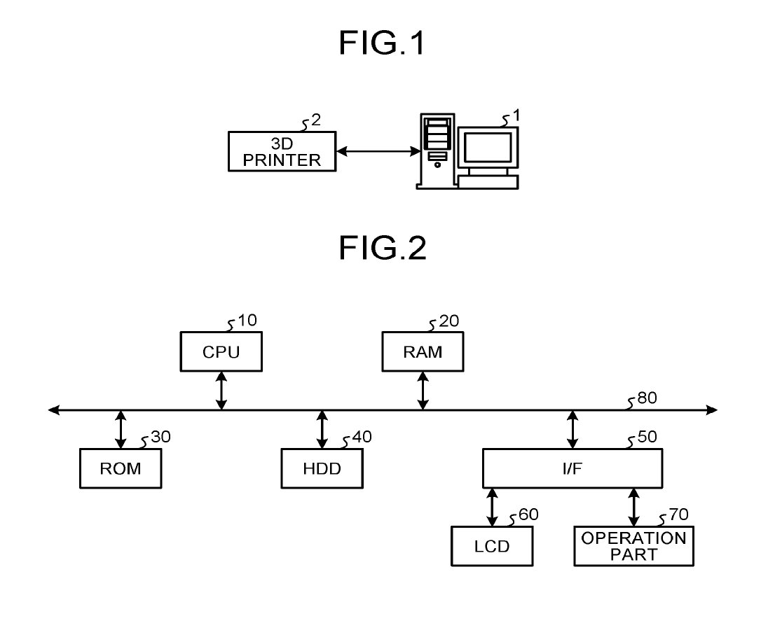

FIG. 1 is a diagram illustrating an operation form of a three-dimensional shaping system according to the present embodiments. The three-dimensional shaping system according to the present embodiments includes a PC 1 that analyses input 3D data to convert the data and causes the 3D printer being the three-dimensional shaping apparatus to execute three-dimensional shaping output and a 3D printer 2 that executes the three-dimensional shaping output according to the control of the PC 1. Therefore, the 3D printer 2 is also used as a producing device of the three-dimensional object. The hardware configuration of the PC 1 will be explained below with reference to FIG. 2.

As illustrated in FIG. 2, the PC 1 according to the present embodiments includes the same components as a general information processing device. That is, the PC 1 according to the present embodiments includes a central processing unit (CPU) 10, a random access memory (RAM) 20, a read only memory (ROM) 30, a hard disk drive (HDD) 40, and an interface (I/F) 50, which are connected to each other via a bus 80. The I/F 50 is connected with a liquid crystal display (LCD) 60 and an operation part 70.

The CPU 10 is a computing unit, and controls the overall operation of the PC 1. The RAM 20 is a volatile storage medium capable of high speed reading and writing of information and is used as a work area when the CPU 10 processes the information. The ROM 30 is a read-only nonvolatile storage medium, and stores programs such as firmware. The HDD 40 is a nonvolatile storage medium capable of reading and writing information, and stores an operating system (OS), various types of control programs, and application programs, and the like.

The I/F 50 connects the bus 80 and various hardware and networks, etc. for control. The LCD 60 is a visual user interface through which a user checks the status of the PC 1. The operation part 70 is a user interface, such as a keyboard and a mouse, with which the user inputs information to the PC 1.

In the hardware configuration, the CPU 10 performs computation according to the program stored in the ROM 30 and the program loaded into the RAM 20 from the storage medium such as the HDD 40 or an optical disk (not illustrated), to thereby configure a software control unit. A functional block for implementing the functions of the PC 1 according to the present embodiments is implemented by a combination of the software control unit configured in this manner and the hardware.

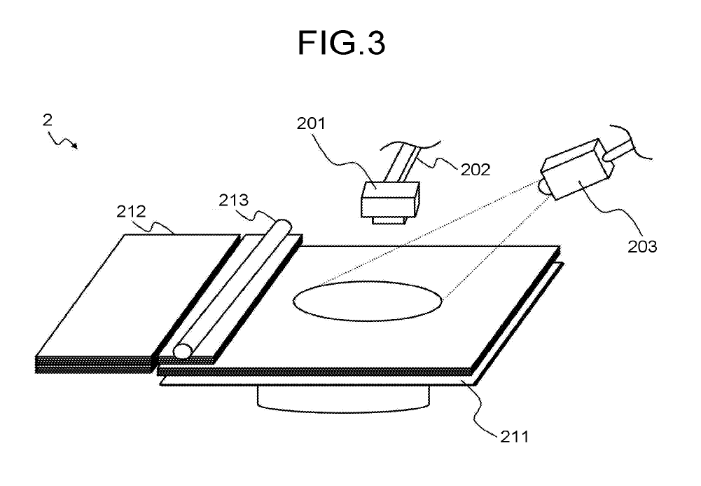

The configuration of the 3D printer 2 according to the present embodiments will be explained next with reference to FIG. 3. The 3D printer 2 according to the present embodiments includes a shaping stage 211 on which a molding material is laminated to mold a three-dimensional object, a powder feed base 212 for feeding a powder material to the shaping stage 211, a recoater 213 that feeds the powder material on the powder feed base 212 to the shaping stage 211, an inkjet (IJ) head 201 that discharges a binder liquid P for binding the powder material fed to the shaping stage 211, an arm 202 that supports the IJ head 201 and moves the IJ head 201 in a space above the shaping stage 211, and a projector 203 that projects an image onto the shaping stage 211. The projector 203 is fixed to a housing of the 3D printer 2, and a positional relationship between the projector 203 and a reference position of the shaping stage 211 is fixed. The position information of the projector 203 is previously transmitted to the PC 1 and is stored in a storage medium such as the HDD 40 of the PC 1.

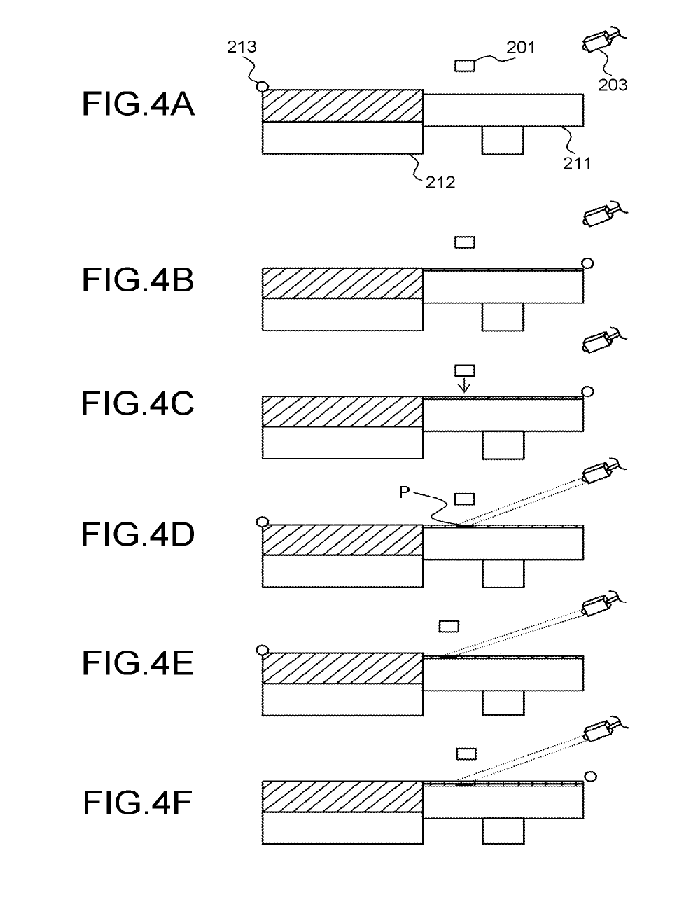

As explained above, the 3D printer 2 discharges the binder liquid P from the IJ head 201 according to a slice image generated by horizontally dividing the three-dimensional shaped object, of which shape is expressed by the input 3D data, into round slices. The discharged binder liquid P binds the powder material fed to the shaping stage 211, molding for one layer is thereby perform, and such layers are laminated to carry out three-dimensional shaping. Moreover, the 3D printer 2 according to the present embodiments includes the projector 203, and projects a slice image onto the shaping stage 211. A molding operation for one layer according to the present embodiments will be explained below with reference to FIGS. 4A to 4F.

As illustrated in FIG. 4A, the powder material is loaded on the powder feed base 212. The recoater 213 moves and extrudes the powder material loaded on the powder feed base 212 to the shaping stage 211, so that the powder material for one layer is fed to the shaping stage 211 as illustrated in FIG. 4B.

When the powder material is fed to the shaping stage 211 as illustrated in FIG. 4B, then, as illustrated in FIG. 4C, the binder liquid P is discharged from the IJ head 201 to the position corresponding to the slice image data. The binder liquid P is a binding agent for binding the powder material. Thus, as illustrated in FIG. 4D, some part of the powder material discharged with the binder liquid P is selectively bound according to the slice image data. Furthermore, at this time, the projector 203 projects the projection data onto the shaping stage 211, based on the slice image data referenced when the binder liquid P is discharged by the IJ head 201. In other words, the IJ head 201 and the arm 202 function as a binding agent discharging unit that selectively discharges the binder liquid P to the flat fed powder material at the position determined based on the information for the three-dimensional object to be molded and laminates the layer of the molding material made of the binder liquid P and the powder material. The projector 203 functions as an image projecting unit that projects the slice image data.

When the molding for one layer is complete as illustrated in FIG. 4D, the height between the shaping stage 211 and the powder feed base 212 is adjusted as illustrated in FIG. 4E, and the recoater 213 is moved again to provide the layer of the powder material for a new layer on the already molded layer as illustrated in FIG. 4F. Such operations are repeated to laminate the molded layers made of the bound powder material to perform three-dimensional shaping. Moreover, in the process of the three-dimensional shaping, it is possible to visually check, using the function of the projector 203, the position on the shaping stage 211 at which the molded layer is laminated. In other words, the shaping stage 211, the powder feed base 212, and the recoater 213 function as a powder material feeder that feeds a powder material flat so as to be deposited in a vertical direction.

The 3D printer 2 also includes an information processing function equivalent to the configuration explained in FIG. 2. A control unit that receives the control from the PC 1 by the information processing function and that is implemented by the information processing function controls the adjustment of the height between the shaping stage 211 and the powder feed base 212, the movement of the recoater 213, the movement of the arm 202, the discharge of the molding material from the IJ head 201, and the projection of an image from the projector 203.

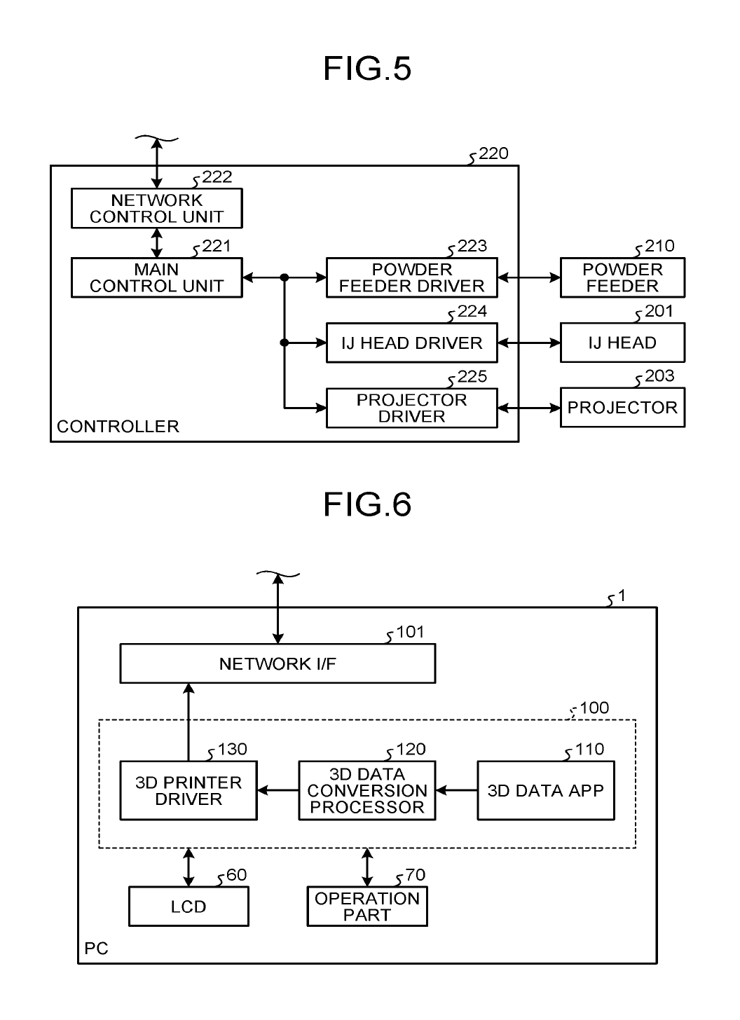

The configuration for the control of the 3D printer 2 according to the present embodiments will be explained next with reference to FIG. 5. As illustrated in FIG. 5, the 3D printer 2 according to the present embodiments includes a powder feeder 210 implemented by the powder feed base 212 and the recoater 213, the IJ head 201, the projector 203, and a controller 220 that controls the powder feeder 210, the IJ head 201, and the projector 203.

The controller 220 includes a main control unit 221, a network control unit 222, a powder feeder driver 223, an IJ head driver 224, and a projector driver 225. The main control unit 221 is a control unit that controls the whole in the controller 220 and is implemented by the CPU 10 performing operations according to the OS and the application programs. The network control unit 222 is an interface through which the 3D printer 2 exchanges information with other devices such as the PC 1, and Ethernet (registered trademark) or a Universal Serial Bus (USB) interface is used. Therefore, the network control unit 222 and the main control unit 221 function as a layer information acquiring unit that acquires slice data from the PC 1.

The powder feeder driver 223 and the IJ head driver 224 are pieces of driver software for controlling the drive of the powder feeder 210 and the IJ head 201 respectively, and control the drive of the powder feeder 210 and the IJ head 201 respectively according to the control of the main control unit 221. The projector driver 225 is driver software for projecting the image data transmitted from the PC 1 to the 3D printer 2 from the projector 203. The operations explained in FIGS. 4A to 4F are implemented by the drive control executed by these pieces of software.

The functional configuration of the PC 1 according to the present embodiments will be explained next with reference to FIG. 6. As illustrated in FIG. 6, the PC 1 according to the present embodiments includes a controller 100 and a network I/F 101 in addition to the LCD 60 and the operation part 70 as explained in FIG. 2. The network I/F 101 is an interface through which the PC 1 communicates with other devices through the network, and Ethernet (registered trademark) or a Universal Serial Bus (USB) interface is used.

The controller 100 is implemented by a combination of the software and the hardware, and functions as a control unit for controlling the entire PC 1. As illustrated in FIG. 6, the controller 100 includes a 3D data app 110, a 3D data conversion processor 120, and a 3D printer driver 130 that provides a function for the PC 1 to control the 3D printer 2, as functions according to the gist of the present embodiments.

The 3D data app 110 is a software application such as CAD software for processing data used to express a three-dimensional shape of a shaped object.

The 3D data conversion processor 120 is a 3D information processor for acquiring the input 3D data and performing conversion processing. That is, the program for implementing the 3D data conversion processor 120 is used as a 3D information processing program. The input of the 3D data to the 3D data conversion processor 120 includes, for example, a case where the 3D data conversion processor 120 acquires the data input to the PC 1 through the network and a case where the 3D data conversion processor 120 acquires the data of a file path specified by a user operation for the operation part 70.

The 3D data conversion processor 120 generates layer information for each layer obtained by slicing a three-dimensional object formed by the 3D data (hereinafter, “slice data”) based on the 3D data acquired in that manner. The 3D data conversion processor 120 according to the present embodiments generates projection data, as the processing according to the gist of the present embodiments, which is information to be projected onto the shaping stage 211 based on the slice data. The processing will be explained in detail later.

The 3D printer driver 130 is a software module for operating the 3D printer 2 through the PC 1, and generates a job for operating the 3D printer 2 based on the slice data and the projection data generated by the 3D data conversion processor 120 and transmits the job to the 3D printer 2. Therefore, the slice data corresponds to shaping information for shaping a divided three-dimensional object.

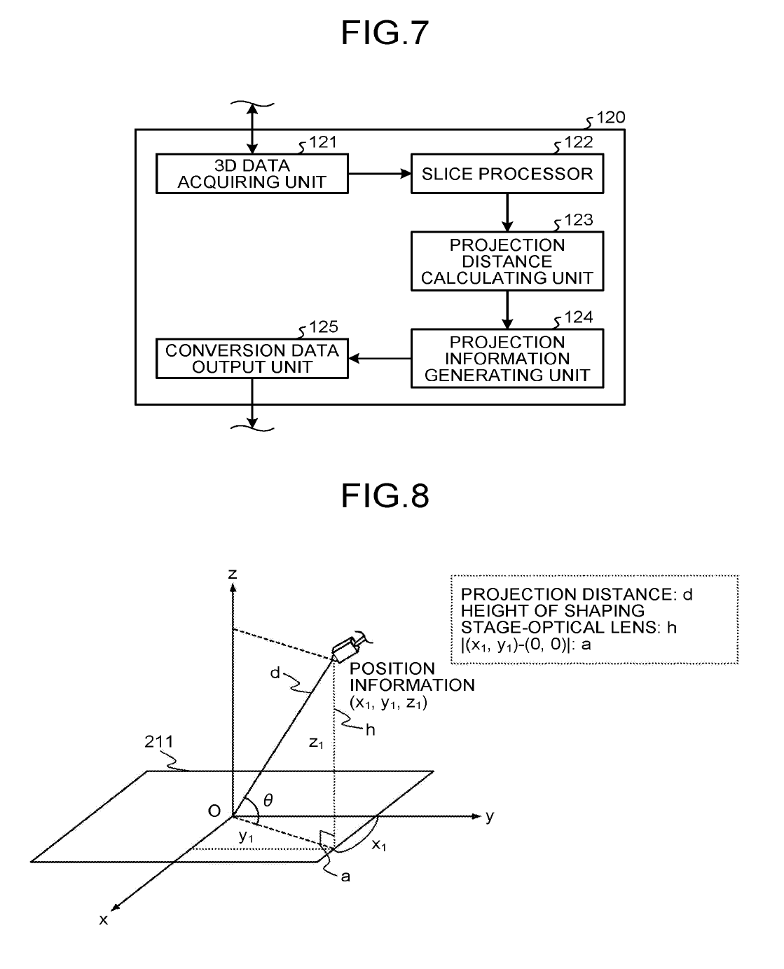

The functions included in the 3D data conversion processor 120 according to the present embodiments will be explained next with reference to FIG. 7. As illustrated in FIG. 7, the 3D data conversion processor 120 according to the present embodiments includes a 3D data acquiring unit 121, a slice processor 122, a projection distance calculating unit 123, a projection information generating unit 124, and a conversion data output unit 125.

The 3D data acquiring unit 121 acquires the 3D data input to the 3D data conversion processor 120. As explained above, the 3D data is target object three-dimensional shape information indicating a three-dimensional shape of a target object to be shaped. The slice processor 122 generates slice data based on the 3D data acquired by the 3D data acquiring unit 121. At this time, each of the slice data is generated in such a manner that the 3D data is divided to a thickness corresponding to one feed portion of the powder material.

The projection distance calculating unit 123 calculates, as illustrated in FIG. 8, a distance (hereinafter, “projection distance”) between a lens of the projector 203 and a shaping surface of the shaping stage 211 based on the position information of the projector 203 and the height information of the shaping stage 211 which are previously input to the PC 1. The projection distance calculated by the projection distance calculating unit 123 is used in the processing for generating the projection data. The present embodiments are configured to calculate a distance between two points connecting the center of the shaping stage 211 and the optical lens of the projector 203 as the projection distance. The details about the calculation of the projection distance will be explained later along with the explanation about the generation of the projection data.

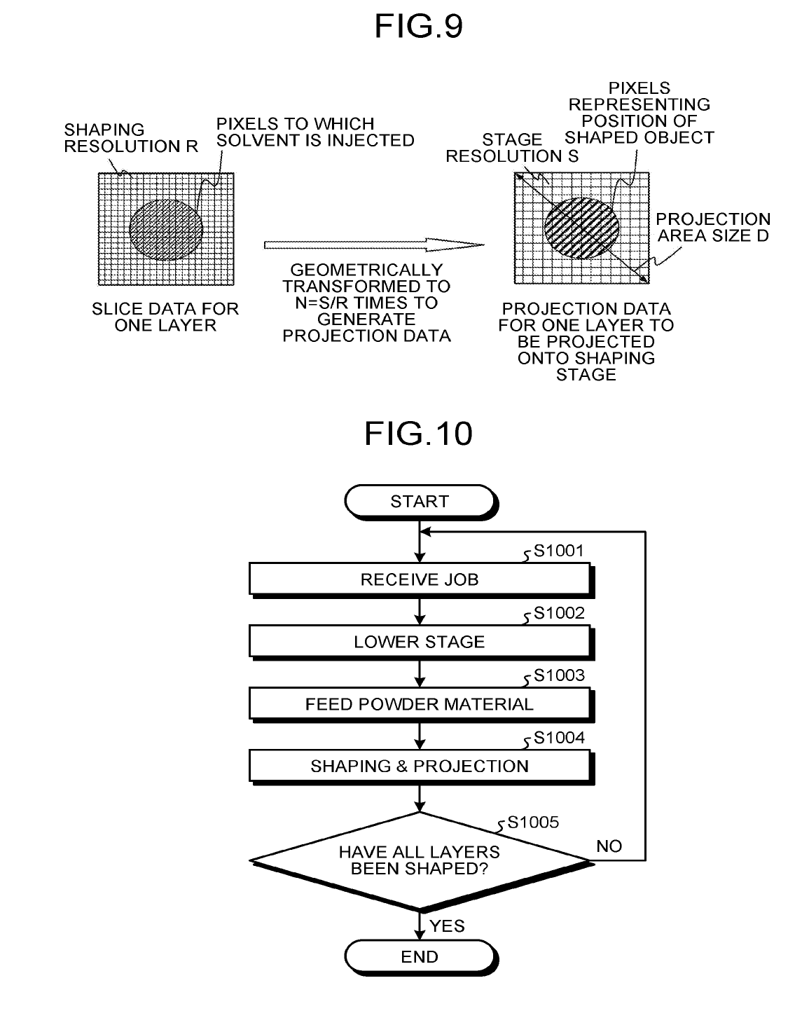

The projection information generating unit 124 generates projection data based on the slice data generated by the slice processor 122 and the projection distance calculated by the projection distance calculating unit 123. How to generate the projection data will be explained herein with reference to FIG. 8 and FIG. 9. FIG. 8 is a schematic diagram of the 3D printer 2, a left diagram of FIG. 9 represents slice data, and a right diagram of FIG. 9 represents projection data. The projection information generating unit 124 according to the embodiments performs geometric transformation on two-dimensional image information of the slice data based on a projection distance d, a focal length of the optical lens of the projector 203, and a projection resolution of the projector 203, and generates the projection data. Before generation of the projection data, the projection distance calculating unit 123 calculates a projection distance. The processing executed by the projection distance calculating unit 123 will be explained below with reference to FIG. 8.

In the present embodiments, position information (x₁, y₁, z₁) of the projector 203 is previously stored in the PC 1. The projection distance calculating unit 123 refers to the position information (x₁, y₁, z₁), the change of the position in a Z direction of the shaping stage 211 in association with the feed of the powder material, and a thickness of lamination of the powder material, to calculate a height h from the shaping surface on the shaping stage 211 to the optical lens of the projector 203 as illustrated in FIG. 8.

Moreover, the projection distance calculating unit 123 refers to the position information (x₁, y₁, z₁) to calculate a distance a between a center O and a point (x₁, y₁) on the shaping stage 211 as illustrated in FIG. 8. When the distance a is calculated, as illustrated in FIG. 8, a right triangle consisting of three sides of the distance a, the projection distance d, and the height h is formed. At this time, it is possible to calculate the projection distance d, based on d²=h²+a², using the property of the lengths of sides of a right triangle.

How to generate the projection data will be explained nest with reference to FIG. 9. First of all, the projection information generating unit 124 refers to a focal length f of the lens of the projector 203 previously stored in the PC 1 and the projection distance d calculated by the projection distance calculating unit 123 to calculate a projection area size which is a size of an image to be projected onto the shaping stage 211. The projection area size in this case can be obtained using an imaging formula from (Projection distance d−Focal length f)/Focal length f=(Projection area size/Projection device size of projector 203). The projection device size of the projector 203 indicates a size of a display device such as a digital mirror device (DMD) and a liquid crystal display mounted on a general projector. In the present embodiments, the projection area is a square.

If the diagonal of the projection area size is D, a resolution of an image (hereinafter, “stage resolution S”) to be projected onto the shaping stage 211 can be obtained from the length D and the projection resolution of the projector 203. The stage resolution S is calculated by Stage resolution S=(Projection resolution of projector 203)/(Length D/√2) using the property of an isosceles right triangle. The projection resolution of the projector 203 in this case corresponds to the resolution of the display device. Moreover, if a resolution of the slice data which is information of pixels to which the binder liquid P is discharged at the time of shaping is “slice resolution R”, a ratio N between the slice resolution R and the stage resolution S can be obtained as N=S/R. When the slice data is geometrically transformed to increase the slice data by N times in the vertical and horizontal directions using the ratio N obtained in this manner and the obtained slice data is projected onto the shaping stage 211, an image of a size corresponding to one layer of the three-dimensional object shaped by the slice data can be projected on the shaping stage. Therefore, the projection information generating unit 124 geometrically transforms the slice data to be increased by N times in the vertical and horizontal directions to generate projection data.

The conversion data output unit 125 outputs the slice data generated by the slice processor 122 and the projection data generated by the projection information generating unit 124 to the 3D printer driver 130. Thereby, the 3D printer driver 130 generates a job for operating the 3D printer 2 based on the slice data and the projection data and transmits the job to the 3D printer 2.

As illustrated in FIG. 8, because an optical axis of the projector 203 is not vertical with respect to the shaping stage 211, distortion occurs in the image projected on the shaping stage 211. The distortion is corrected by the projector driver 225 according to an angle θ between the side a and the side d illustrated in FIG. 8.

The operation of the 3D printer 2 having received the job will be explained next with reference to FIG. 10. When receiving the job including the slice data and the projection data sent from the PC 1 (S1001), the main control unit 221 controls the powder feeder driver 223 to lower the shaping stage 211 by an amount corresponding to the thickness of the layer shaped by one-layer slice data (S1002). When the shaping stage 211 is lowered, the main control unit 221 controls the powder feeder driver 223 to operate the recoater 213, and thereby feeds the powder material from the powder feed base 212 to the shaping stage 211 (S1003). Subsequently, the main control unit 221 controls the IJ head driver 224 to move the arm 202 and thereby moves the IJ head 201 to a position of each pixel.

After the IJ head 201 is moved, the main control unit 221 refers to the slice data and the projection data. The main control unit 221 transmits the referred projection data to the projector driver 225 so as to project the projection data on the powder material fed to the shaping stage 211. Moreover, in the slice data, when the position of the IJ head 201 is part of the three-dimensional object to be shaped, the main control unit 221 performs the control to discharge the binder liquid P (S1004). At this time, when the position of the IJ head 201 is not part of the three-dimensional object to be shaped, the main control unit 221 performs the control not to discharge the binder liquid P. The main control unit 221 repeats the processing at S1004 until the processing for one layer is complete.

When the processing for one layer is complete, the main control unit 221 repeats the processing from the feed of the powder material for a new layer until the processing for all the layers is complete (No at S1005), and ends the processing when the processing for all the layers is complete (Yes at S1005). With the processing, the operation of the 3D printer 2 having received the job is complete.

As explained above, the 3D printer 2 according to the present embodiments projects the projection data onto the powder material at the area where the shaping is performed, and can thereby confirm the position of the three-dimensional object on the shaping stage 211. Thus, it is possible to visually confirm the position of the three-dimensional object in the laminated powder material and to reduce the damage that may occur when the shaped three-dimensional object is taken out therefrom.

A case in which a plurality of three-dimensional objects are concurrently shaped can be considered depending on the size of the three-dimensional object. In this case, the 3D printer 2 projects slice data of the three-dimensional objects generated by a function implemented in the slice processor 122 onto the shaping stage 211.

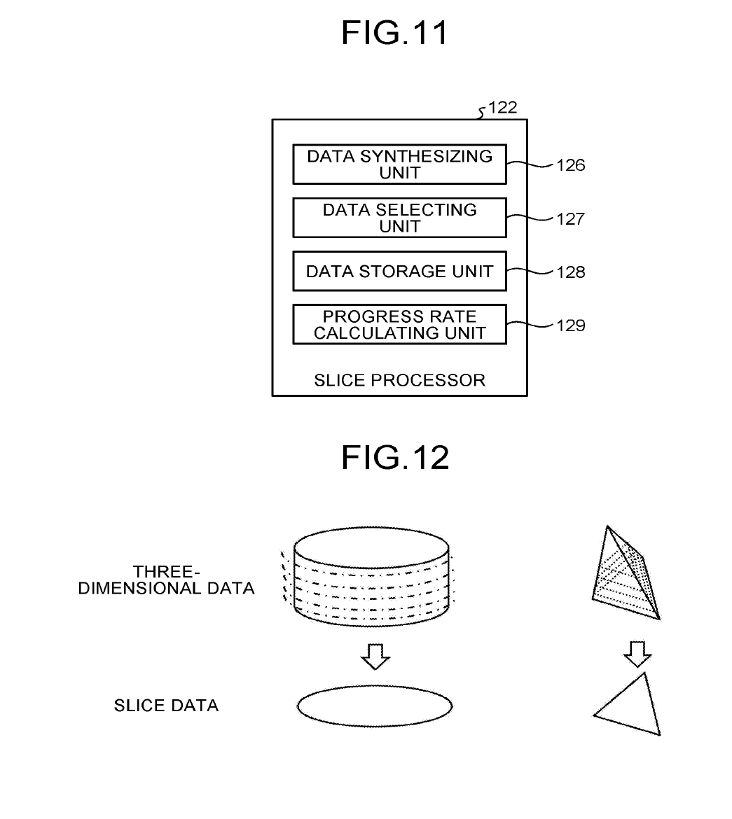

Various functions included in the slice processor 122 will be explained herein with reference to FIG. 11. As illustrated in FIG. 11, the slice processor 122 includes a data synthesizing unit 126, a data selecting unit 127, a data storage unit 128, and a progress rate calculating unit 129.

When the three-dimensional objects are to be concurrently shaped, the data synthesizing unit 126 synthesizes slice data generated from the 3D data input to the 3D data conversion processor 120. The data selecting unit 127 receives information of an operation performed by the user from the PC 1 and performs a selection of the projection data corresponding to the information of the operation. The data storage unit 128 stores the projected projection data in the RAM 20 and the HDD 40, etc. The progress rate calculating unit 129 compares the slice data and the 3D data, and adds the information of the progress rate in the shaping process to each of the slice data. The details of the processing executable by the functions included in the slice processor 122 will be explained below.

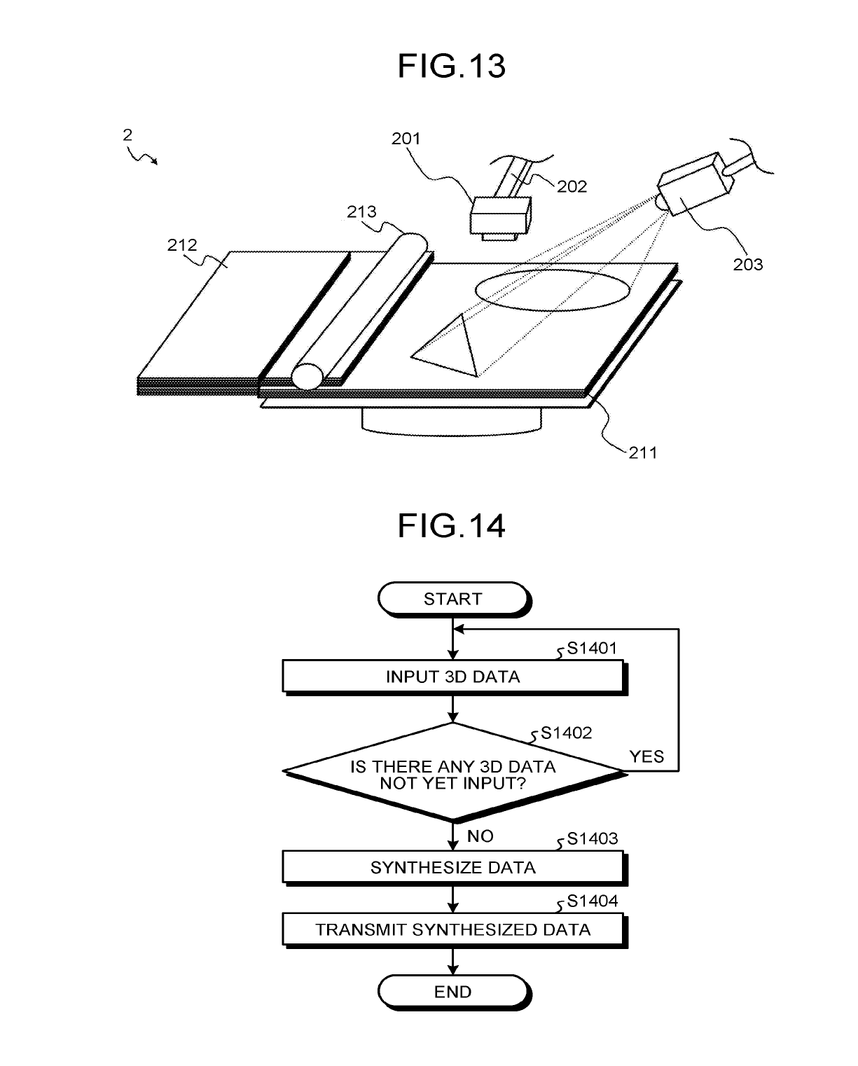

FIG. 12 is a diagram illustrating 3D data of a plurality of three-dimensional objects. As illustrated in FIG. 12, when the 3D printer 2 is made to concurrently perform shaping of the three-dimensional objects, the data synthesizing unit 126 synthesizes the respective slice data of the three-dimensional objects to be shaped in the same layer of the powder material. Then, as illustrated in FIG. 13, the 3D printer 2 performs shaping and projection onto the powder material based on the synthesized slice data.

FIG. 14 is a flowchart illustrating operations when the 3D data conversion processor 120 synthesizes the slice data of the three-dimensional objects. First of all, the 3D data of the three-dimensional objects are input to the 3D data conversion processor 120 from the 3D data app 110 (S1401). When receiving the 3D data, the 3D data acquiring unit 121 determines whether there is no 3D data not yet input (S1402). When there is any 3D data not yet input (Yes at S1402), the 3D data acquiring unit 121 waits for 3D data until the 3D data is input again and repeats the processing at S1401 and S1402 until all the 3D data are input. When all the 3D data are input (No at S1402), the 3D data acquiring unit 121 transmits the input 3D data to the slice processor 122. The slice processor 122 performs slice processing on each of the 3D data received from the 3D data acquiring unit 121, and transmits the data to the data synthesizing unit 126. The data synthesizing unit 126 synthesizes the generated slice data to generate slice data for one layer (S1403).

The 3D data conversion processor 120 generates projection data based on the slice data synthesized by the data synthesizing unit 126, and transmits the projection data to the 3D printer driver 130 (S1404). The 3D printer driver 130 generates a job for operating the 3D printer 2 based on the synthesized slice data and the projection data and transmits the job to the 3D printer 2. With the processing of the 3D data in the PC 1, it is possible to simultaneously project a plurality of projection data onto the powder material on the shaping stage 211 as illustrated in FIG. 13.

An operation of the PC 1 performed by the user is received in the 3D data app 110, so that arrangement of the 3D data of the three-dimensional objects is determined. Therefore, when a cylinder and a triangular pyramid are concurrently shaped as illustrated in FIG. 12, the three-dimensional objects can be respectively arranged in positions arbitrarily specified by the user.

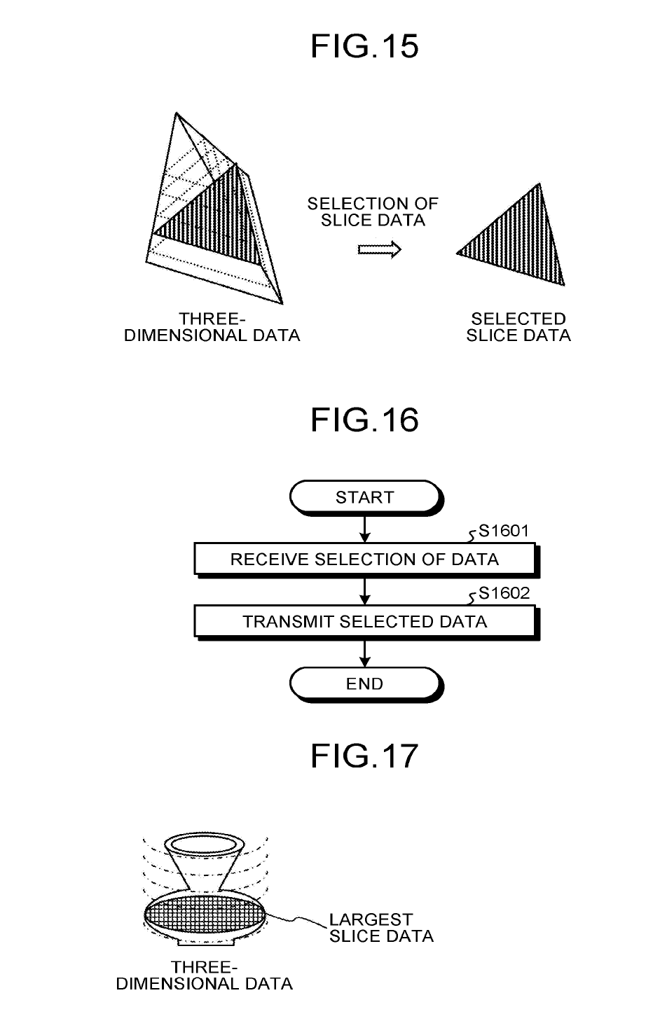

FIG. 15 is a diagram illustrating an example of selecting slice data of the three-dimensional object. When the three-dimensional object having the shape as illustrated in FIG. 15 is to be shaped, the three-dimensional object to be shaped is buried in unfixed powder material in a device that performs the powder laminating shaping. Therefore, because the area of the slice data is small and the projection range becomes small when a vertex is shaped, a position where the three-dimensional object is buried cannot be effectively presented to the user. Therefore, as illustrated in FIG. 15, the present embodiments are configured to select slice data of the three-dimensional object, to project the projection data generated based on the selected slice data on the shaping stage 211, and to present a buried position of the three-dimensional object. The selection of the slice data of the three-dimensional object is implemented, as illustrated in the flowchart of FIG. 16, when an operation of the PC 1 performed by the user is received and the data selecting unit 127 selects which of slice data is to be projected based on the reception signal (S1601). The selected slice data is converted into the projection data by the projection information generating unit 124, the converted projection data is transmitted from the 3D printer driver 130 to the 3D printer 2 (S1602), and is projected onto the shaping stage 211.

In the present embodiments, slice data arbitrarily specified by the user can be projected on the shaping stage 211. For example, when the shaping is carried out while changing color of the powder material, because the projection data for a shaping layer arbitrarily specified by the user is projected on the shaping stage 211, it is possible to confirm the details of the position of the shaping layer specified by the user in the shaping process.

FIG. 17 is a diagram illustrating slice data included in the 3D data of the three-dimensional object. When the three-dimensional object as illustrated in FIG. 17 is to be shaped, the slice data largely changes in the shaping process. Therefore, the present embodiments are configured to perform the control to automatically project largest projection data on the shaping stage 211 after completion of the three-dimensional shaping.

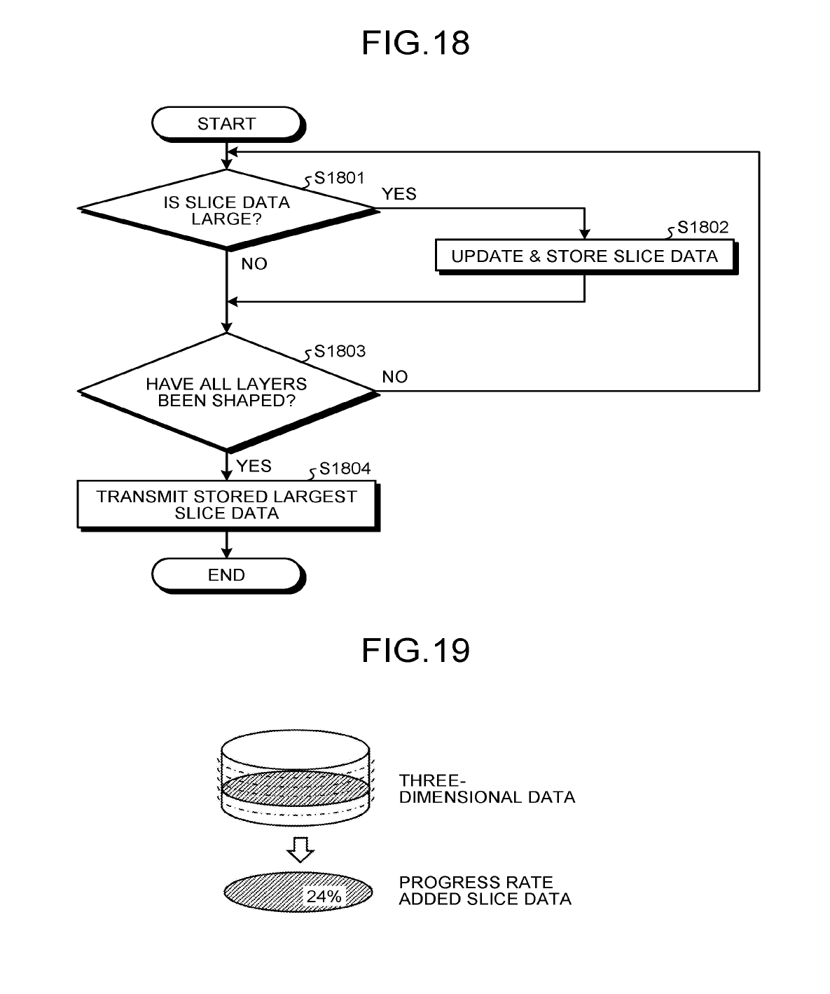

FIG. 18 is a flowchart illustrating an operation for projecting the largest slice data after the shaping. In the processing illustrated in FIG. 18, first of all, when the 3D data input to the 3D data conversion processor 120 is divided to generate slice data, the slice processor 122 determines whether the slice data is large or small (S1801). When newly generated slice data is the largest (Yes at S1801), the slice processor 122 stores the newly generated slice data in the data storage unit 128 (S1802). At this time, when there is already stored slice data, the slice processor 122 updates the slice data with the newly generated slice data as the largest slice data, and stores the updated slice data in the data storage unit 128. Therefore, when the newly generated slice data is smaller than the stored slice data, the slice processor 122 does not update the slice data (No at S1801).

Subsequently, the slice processor 122 determines whether the shaping processing based on the slice data is completely performed and shaping of the three-dimensional object is complete (S1803). When the shaping of the three-dimensional object is not complete (No at S1803), the slice processor 122 performs slice processing on any 3D data not shaped, and performs the processing again from S1801. When the shaping of the three-dimensional object is complete (Yes at S1803), the slice processor 122 refers to the data storage unit 128 to perform the processing of projecting the largest slice data (S1804). In the processing, the largest slice data is projected onto the powder material on the shaping stage 211. Therefore, the projection distance calculating unit 123 calculates a projection distance at the time of shaping completion. The calculated projection distance is transmitted to the projection information generating unit 124, and becomes data used at the time of geometric transformation from the slice data to the projection data. The projection data generated through the geometric transformation is projected from the projector 203 onto the shaping stage 211 by the 3D printer driver 130.

By projecting the largest slice data onto the shaping stage 211 in this manner, it is possible to visually recognize the size of the three-dimensional object even if the three-dimensional object is buried in the powder material. Therefore, it is possible to reduce any damage that may occur when the three-dimensional object is taken out after the completion of the shaping. In the present embodiments, sizes of pixel areas representing the positions of shaped objects are compared with each other to determine the sizes of the projection data.

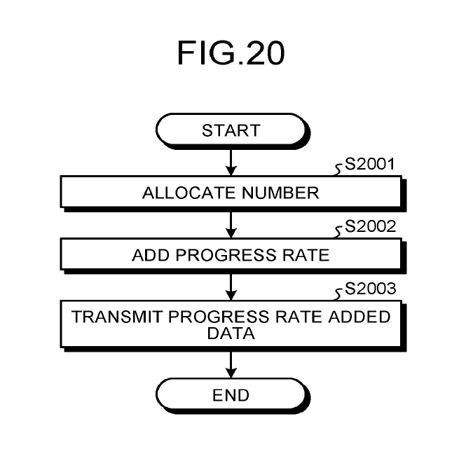

FIG. 19 is a diagram illustrating the form of projection data added with information of a progress rate in the shaping process. The operations performed when the projection data added with information of the progress rate in the shaping process is projected will be explained below with reference to FIG. 19 and FIG. 20.

The slice processor 122 sequentially allocates a number to the slice data generated at the time of the slice processing performed on the input 3D data (S2001). The allocation of the number at this time is used as information for forming a layer of the molding material in the shaping process.

The progress rate calculating unit 129 calculates a progress rate in each of the slice data based on the number allocated to the slice data and the maximum value of the number, and adds the calculation result to the slice data (S2002). The slice data added with the progress rate in this manner is transmitted to the projection distance calculating unit 123 (S2003), and is used as the slice data and the projection data in the processing at S1004. Information indicating the progress rate based on the number allocated to the slice data may be added.

The form of the slice data after the progress rate is added may be a form in which the progress rate is displayed as character information in the projection data or the progress rate is displayed on the 3D printer 2 based on the slice data.

As explained above, in the processing performed when the slice processing of the 3D data is executed, the slice processor 122 according to the present invention projects the detailed position of the shaped object or generates the projection data that reflects the progress rate. When shaping of a plurality of 3D data is concurrently performed, respective slice data are generated and the generated slice data are synthesized, and the synthesized 3D data is projected onto the shaping stage 211. These processings implemented by the functions included in the slice processor 122 may be independently performed, respectively, and a combination of some of the processings may be executed. By causing the slice processor 122 to execute the processings, it is possible to perform localization of a three-dimensional object on the shaping stage 211 not only at the time of shaping each of the shaping layer of the three-dimensional object but also before the shaping or after the completion of the shaping.

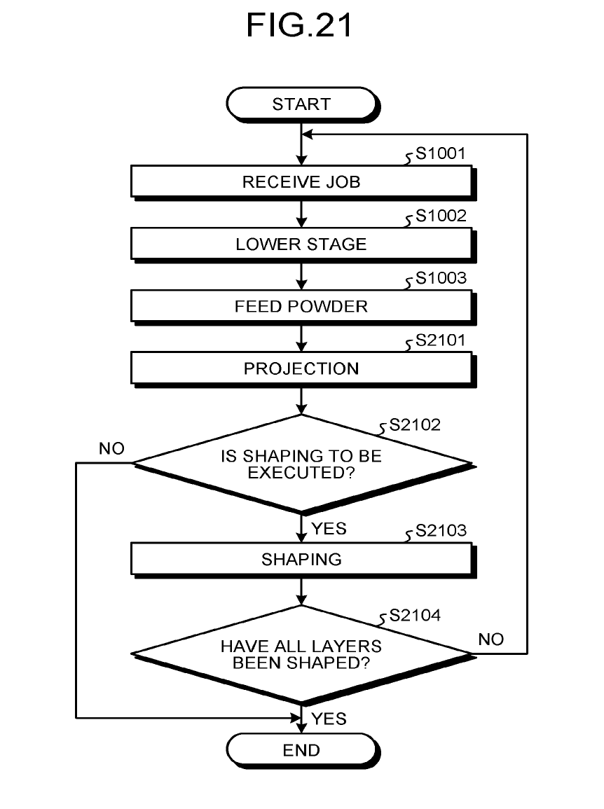

When a three-dimensional object having a complicated structure is to be shaped, it is desirable to perform shaping after checking positions where the shaping is performed, on the shaping stage 211. In this case, after the projection data is projected onto the shaping stage 211, it is possible to receive a user input to the PC 1 and to determine whether to execute the shaping. The operation of determining whether the shaping is possible after the projection will be explained below with reference to FIG. 21. In the processing illustrated in the flowchart of FIG. 21, the processings up to S1003 are the same as FIG. 10, and therefore, explanation thereof is omitted. The explanation will be continued from the processing after the slice data and the projection data are input to the 3D printer 2 and the powder material is fed to the shaping stage 211.

When the powder material is fed to the shaping stage 211, the main control unit 221 refers to the projection data and the slice data to transmit the referred projection data to the projector driver 225. The projector 203 projects the projection data onto the powder material fed to the shaping stage 211 (S2101). When the projection is performed by the projector 203, the main control unit 221 transmits a request to determine whether the shaping based on the slice data is to be performed to the PC 1 through the network control unit 222. The user operates the PC 1 to input information as to whether to perform the shaping of an area corresponding to the slice data projected on the shaping stage 211.

When accepting the operation for the PC 1 by the user to receive a signal indicating that execution of the shaping is possible (Yes at S2102), the 3D printer driver 130 transmits a job for causing the 3D printer 2 to execute the shaping based on the slice data corresponding to the projection data to the 3D printer 2. The 3D printer 2 performs the shaping of the area corresponding to the projection data based on the job (S2103). The 3D printer 2 repeatedly executes processings at S1001 to S2103 until all the slice data corresponding to the 3D data are shaped (No at S2104).

When accepting the operation for the PC 1 by the user to receive a signal indicating that execution of the shaping is not possible (No at S2102), the 3D printer driver 130 stops the shaping, and transmits a job for terminating all the processings to the 3D printer 2. The processing for determining whether execution of the shaping is possible after the projection processing as illustrated in FIG. 21 can be applied in all the embodiments. In this way, by projecting an actual shaping image on the shaping stage 211 before the shaping is performed, it is possible to confirm a layer to be newly shaped and execute three-dimensional shaping.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A three-dimensional shaping apparatus configured to laminate layers of a molding material based on input information to shape a three-dimensional object, comprising:
a powder material feeder configured to feed a powder material flat so as to be vertically deposited;
a layer information acquiring unit configured to acquire layer information generated in such a manner that information indicating a shape of the three-dimensional object is divided so as to correspond to the layers of the molding material;
a binding agent discharging unit configured to discharge a binding agent for binding the powder material selectively to the flat fed powder material at a position determined based on the layer information, to bind the powder material to form the layers of the molding material; and
an image projecting unit configured to project an image onto a flat surface of the powder material based on projection information generated according to the layer information.

2. The three-dimensional shaping apparatus according to claim 1, wherein
the layer information acquiring unit is configured to acquire the layer information including information corresponding to the layers of the molding material for a plurality of three-dimensional objects,
the binding agent discharging unit is configured to discharge the binding agent to different positions in the flat fed powder material based on the information corresponding to the layers of the molding material for the plurality of three-dimensional objects, and
the image projecting unit is configured to project the image on different positions in the surface of the flat fed powder materials based on the projection information generated according to the information corresponding to the layers of the molding material for the plurality of three-dimensional objects.

3. The three-dimensional shaping apparatus according to claim 1, wherein the image projecting unit is configured to, if a signal for specifying layer information is input to the three-dimensional shaping apparatus, project the image based on the projection information generated according to the specified layer information.

4. The three-dimensional shaping apparatus according to claim 1, wherein the image projecting unit is configured to project the image based on the projection information generated according to information on a layer in which an area of the three-dimensional object is largest, of the layer information.

5. The three-dimensional shaping apparatus according to claim 1, wherein
the layer information acquiring unit is configured to acquire information, about the layer information, indicating an order used as information for forming the layers of the molding material, and
the image projecting unit is configured to project a progress rate of shaping of the three-dimensional object onto the flat surface of the powder material based on the acquired information indicating the order.

6. A three-dimensional shaping method for laminating layers of a molding material based on input information to shape a three-dimensional object, the three-dimensional shaping method comprising:
feeding a powder material flat so as to be vertically deposited;
acquiring layer information generated in such a manner that information indicating a shape of the three-dimensional object is divided so as to correspond to the layers of the molding material;
discharging a binding agent for binding the powder material selectively to the flat fed powder material at a position determined based on the layer information, to bind the powder material to form the layers of the molding material; and
projecting an image onto a flat surface of the powder material based on projection information generated according to the layer information.

7. The three-dimensional shaping method according to claim 6, wherein
at the acquiring, the layer information including information corresponding to the layers of the molding material for a plurality of three-dimensional objects are acquired,
at the discharging, the binding agent is discharged to different positions in the flat fed powder material based on the information corresponding to the layers of the molding material for the plurality of three-dimensional objects, and
at the projecting, the image is projected on different positions in the surface of the flat fed powder materials based on the projection information generated according to the information corresponding to the layers of the molding material for the plurality of three-dimensional objects.

8. The three-dimensional shaping method according to claim 6, wherein at the projecting, if a signal for specifying layer information is input, the image is projected based on the projection information generated according to the specified layer information.

9. The three-dimensional shaping method according to claim 6, wherein at the projecting, the image is projected based on the projection information generated according to information on a layer in which an area of the three-dimensional object is largest, of the layer information.

10. The three-dimensional shaping method according to claim 6, wherein
at the acquiring, information, about the layer information, indicating an order used as information for forming the layers of the molding material is acquired, and
at the projecting, a progress rate of shaping of the three-dimensional object is projected onto the flat surface of the powder material based on the acquired information indicating the order.

11. A computer program product for being executed on a computer of a three-dimensional shaping apparatus configured to laminate layers of a molding material based on input information to shape a three-dimensional object, the computer program product causing the three-dimensional shaping apparatus to perform:
feeding a powder material flat so as to be vertically deposited;
acquiring layer information generated in such a manner that information indicating a shape of the three-dimensional object is divided so as to correspond to the layers of the molding material;
discharging a binding agent for binding the powder material selectively to the flat fed powder material at a position determined based on the layer information, binding the powder material, and thereby forming the layer of the molding material; and
projecting an image onto a flat surface of the powder material based on projection information generated according to the layer information.

12. The computer program product according to claim 11, wherein
at the acquiring, the layer information including information corresponding to the layers of the molding material for a plurality of three-dimensional objects are acquired,
at the discharging, the binding agent is discharged to different positions in the flat fed powder material based on the information corresponding to the layers of the molding material for the plurality of three-dimensional objects, and
at the projecting, the image is projected on different positions in the surface of the flat fed powder materials based on the projection information generated according to the information corresponding to the layers of the molding material for the plurality of three-dimensional objects.

13. The computer program product according to claim 11, wherein at the projecting, if a signal for specifying layer information is input, the image is projected based on the projection information generated according to the specified layer information.

14. The computer program product according to claim 11, wherein at the projecting, the image is projected based on the projection information generated according to information on a layer in which an area of the three-dimensional object is largest, of the layer information.

15. The computer program product according to claim 11, wherein
at the acquiring, information, about the layer information, indicating an order used as information for forming the layers of the molding material is acquired, and
at the projecting, a progress rate of shaping of the three-dimensional object is projected onto the flat surface of the powder material based on the acquired information indicating the order.
